(19) United States
(12) Patent Application Publication
(10) Pub. No.: US 2023/0193102 A1
(43) Pub. Date: Jun. 22, 2023

(54) HIGH TEMPERATURE LOW OUTGAS FLUORINATED THERMAL INTERFACE MATERIAL

(71) Applicants: DAIKIN AMERICA, INC., Orangeburg, NY (US); DAIKIN INDUSTRIES, LTD., Osaka-shi, Osaka (JP)

(72) Inventors: Kiyomi TACHIHARA, San Jose, CA (US); Yoshiaki HONDA, San Jose, CA (US); Hisashi MITSUHASHI, Osaka-shi, Osaka (JP); Koji KIGAWA, San Jose, CA (US)

(73) Assignees: DAIKIN AMERICA, INC., Orangeburg, NY (US); DAIKIN INDUSTRIES, LTD., Osaka-shi, Osaka (JP)

(21) Appl. No.: 17/924,943

(22) PCT Filed: May 12, 2021
(86) PCT No.: PCT/JP2021/018073

§ 371 Date: Nov. 11, 2022

Related U.S. Application Data
(60) Provisional application No. 63/024,565, filed on May 14, 2020.

(51) Int. Cl. C09K 5/10; C08K 3/22; C08G 65/00

(52) U.S. Cl. CPC C09K 5/10; C08K 3/22; C08G 65/007; C08K 2003/222; C08K 2003/2296; C08K 2201/001; C08K 2201/005; C08G 2650/48

(57) ABSTRACT

A high temperature low outgas thermal interface material is provided. The thermal interface material includes a plurality of heat conducting particles dispersed within a fluorine containing fluid such as perfluoropolyether. The high temperature low outgas thermal interface material provides thermal conductivity between a heat source and a heat sink at temperatures greater than 200° C.

### TECHNICAL FIELD

This disclosure relates to fluorinated thermal interface materials and more specifically to high temperature low outgas thermal interface materials for use in the electronics, energy storage, and communications industries.

### BACKGROUND ART

This section is intended to introduce the reader to various aspects of the art that may be related to various aspects of the presently described embodiments-to help facilitate a better understanding of various aspects of the present embodiments. Accordingly, it should be understood that these statements are to be read in this light, and not as admissions of prior art.

In an ongoing technical trend, the modern world is using higher data transmission, processing and storage speeds. As big data, the internet of things (IoT) and 5G technologies become more widely adopted, the electronics underlying these developments may utilize more power, release more heat, and operate under harsher conditions. Thermal interface material (TIM) is typically placed between two components in order to facilitate the transfer of heat from a heat source to a heat sink so that a system can dissipate heat and avoid overheating conditions. However, as more advanced computer chips, printed circuit boards, and other electronics process a greater amount of data, they produce a greater amount of heat. Recent technological advancement in the fields of high-speed data transmission and big data computing have resulted in an increase in computer chips and other electronics operating under high temperature conditions and in smaller more dense locations.

Various types of TIMs currently exist including both solid and fluid TIMs. Fluid TIMs have the advantage of reducing or eliminating air gaps between a heat source and a heat sink when compared to solid TIMs. Air gaps reduce the total amount of heat that may be transferred from the heat source to the heat sink and can lead to hot spots that are unable to properly dissipate heat. In some cases, an air gaps between a computer chip and heat sink can cause the chip to overheat and be destroyed.

Many fluid TIMs have a relatively low maximum operating temperature. At least one component of the TIM will start to degrade as the TIM is exposed to higher temperatures. Once the TIM or a component of the TIM starts to degrade, the overall performance of the TIM will decrease. This may lead to improper heat dissipation causing overheating and failure of the heat producing electronics.

### SUMMARY OF INVENTION

### Problem to be Solved by the Invention

Some high temperature TIM materials incorporate silicon fluid which has a maximum acceptable temperature of about 200° C. However, TIM materials incorporating silicon fluid have problems associated with significant off-gassing. TIM off-gassing or outgas emission may interfere with or contaminate sensitive electronics.

What is needed is an improved TIM that is capable of being used at higher temperatures with reduced outgas emissions for sensitive high temperature computer chips, antennas, communication devices, electronics, printed circuit boards, batteries, and/or sensors.

### Means to Solve the Problem

This disclosure relates generally to a thermal interface material for use with high performance and/or sensitive electronics such as those used in, for example, the energy storage, electric vehicles, and communications industries. Embodiments of the present disclosure generally relate to a thermal interface material comprising a modified thermal filler and a carrier fluid.

Disclosed some embodiments relate to a low outgas thermal interface material comprising a heat conductive material dispersed within a perfluoropolyether (PFPE) fluid, wherein the heat conductive material comprises a plurality of heat conductive particles, and wherein the surface of the plurality of heat conductive particles is modified with a fluorine containing surface treatment agent.

In some embodiments, the disclosed thermal interface material comprises at least 80% thermal filler particles by weight. In some embodiments, the thermal filler particles are non-ferrous and/or non-magnetic. In some embodiments, the disclosed thermal interface material out-gasses less than 0.5% of total mass after 72 hours of exposure to a temperature of at least 200° C.

The above presents a simplified summary in order to provide a basic understanding of some aspects of the claimed subject matter. This summary is not an extensive overview. It is not intended to identify key or critical elements or to delineate the scope of the claimed subject matter. Its sole purpose is to present some concepts in a simplified form as a prelude to the more detailed description that is presented later.

### BRIEF DESCRIPTION OF DRAWINGS

The accompanying drawings incorporated in and forming a part of this specification illustrate several aspects of the disclosure, and together with the description serve to explain the principles of the disclosure.

FIG. 1 illustrates a dispersion of heat conducting particles dispersed within a PFPE fluid.

### DESCRIPTION OF EMBODIMENTS

The embodiments set forth below represent the necessary information to enable those skilled in the art to practice the disclosure and illustrate the best mode of practicing the disclosure. Upon reading the following description in light of the accompanying drawings, those skilled in the art will understand the concepts of the disclosure and will recognize applications of these concepts not particularly addressed herein. It should be understood that these concepts and applications fall within the scope of the disclosure and the accompanying claims.

Unless otherwise defined, all terms (including technical and scientific terms) used herein have the same meaning as commonly understood by one of ordinary skill in the art of this disclosure. It will be further understood that terms, such as those defined in commonly used dictionaries, should be interpreted as having a meaning that is consistent with their meaning in the context of the specification and should not be interpreted in an idealized or overly formal sense unless expressly so defined herein. Well known functions or constructions may not be described in detail for brevity or clarity.

The terms “about” and “approximately” shall generally mean an acceptable degree of error or variation for the quantity measured given the nature or precision of the measurements. Typical, exemplary degrees of error or variation are within 20 percent (%), preferably within 10%, and more preferably within 5% of a given value or range of values. Numerical quantities given in this description are approximate unless stated otherwise, meaning that the term “about” or “approximately” can be inferred when not expressly stated. Numerical quantities in the claims are exact unless stated otherwise.

The terminology used herein is for the purpose of describing particular embodiments only and is not intended to be limiting. As used herein, the singular forms “a”, “an” and “the” are intended to include the plural forms as well, unless the context clearly indicates otherwise.

The terms “first”, “second”, and the like are used herein to describe various features or elements, but these features or elements should not be limited by these terms. These terms are only used to distinguish one feature or element from another feature or element. Thus, a first feature or element discussed below could be termed a second feature or element, and similarly, a second feature or element discussed below could be termed a first feature or element without departing from the teachings of the present disclosure.

Terms such as “at least one of A and B” should be understood to mean “only A, only B, or both A and B.” The same construction should be applied to longer lists (e.g., “at least one of A, B, and C”).

The term “consisting essentially of” means that, in addition to the recited elements, what is claimed may also contain other elements (steps, structures, ingredients, components, etc.) that do not adversely affect the operability of what is claimed for its intended purpose as stated in this disclosure. This term excludes such other elements that adversely affect the operability of what is claimed for its intended purpose as stated in this disclosure, even if such other elements might enhance the operability of what is claimed for some other purpose.

In some places reference is made to standard methods, such as but not limited to methods of measurement. It is to be understood that such standards are revised from time to time, and unless explicitly stated otherwise reference to such standard in this disclosure must be interpreted to refer to the most recent published standard as of the time of filing.

Thermal interface materials facilitate the transfer of heat form a heat source to a heat sink or other heat receiving element. The disclosed thermal interface material is a high temperature, low outgas TIM designed to work with sensitive and/or high-performance electronics and electronic components and may assist with new applications of these electronics.

The disclosed thermal interface material generally comprises heat conductive material dispersed within a fluorine containing carrier fluid such as, for example perfluoropolyether (PFPE) fluid.

The disclosed heat conductive material includes a plurality of heat conductive particles. These heat conductive particles are generally in the form of a fine powder of metal and/or metal oxides known to have a high thermal conductivity such as, for example, magnesium, zinc, magnesium oxide and/or zinc oxide.

Metals and metal oxides are not easily dispersed in PFPE fluid. To facilitate a more stable dispersion of heat conductive particles within the PFPE carrier fluid, the surface of the heat conductive particles modified with a surface treatment agent. The surface treatment agent is a molecule with both a metal binding moiety and a fluorine containing moiety. In some embodiments, the surface treatment agent is covalently bound to the surface of the heat conductive particles at the metal binding moiety such that the fluorine containing moiety is presented at the surface of the heat conductive particles.

The modified heat conductive particles may be dispersed within the PFPE fluid using an ultrasonic mixer, homogenizer, or ball mill along with other known methods. In some embodiments, additional steps may be performed to achieve the desired final product. Such steps may include at least purification, evaporation, filtration, and or centrifugation to remove undesirable components from the TIM material. In some embodiments, the TIM dispersion is a high viscosity material. In some embodiments, the thermal interface material is a paste.

In some embodiments, the heat conductive particles are mixed, blended, or added to a fluorine containing fluid such as PFPE fluid before they are modified. In such embodiments, the heat conductive particles may then be modified by reacting the heat conductive particles with a surface treatment agent. As the heat conductive particles react with the surface treatment agent the particles become more easily dispersed within the fluorine containing fluid.

In some embodiments, the fluorine containing fluid and the surface treatment agent are blended prior to the addition of the heat conductive particles. In such embodiments, the surface treatment agent may be dispersed within the fluorine containing fluid and then reacted with the heat conductive particles once the particles are added.

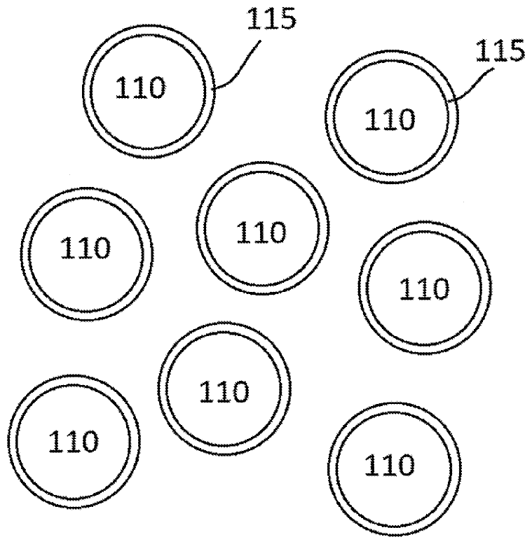

FIG. 1 schematically illustrates a plurality of heat conductive particles 110 with a modified surface 115. The particles 110 are generally dispersed within a PFPE fluid (not shown).

Perfluoro polyether (PFPE) has been used as a lubricant in the aerospace industry. PFPE is temperature resistant at temperatures exceeding 200° C. and has a very low vapor pressure. PFPE fluids are known to produce very little outgas emissions. PFPE fluids have generally not been used in TIMs due to the difficulty of adequately dispersing an effective thermal filler in a fluorine containing fluid. However, a PFPE based TIM provides high temperature operation and low outgas emissions which reduce interference with high sensitivity sensors and electronics.

PFPE is generally available under many tradenames such as, for example, Krytox(Registered Trademark),

Fomblin(Registered Trademark), and Demnum(Registered Trademark). PFPE may be arranged in a variety of molecular structures including at least the following:

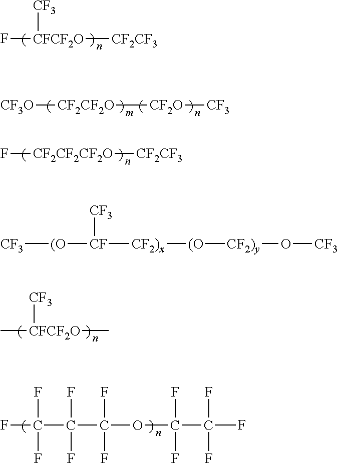

In some embodiments, the PFPE fluid has a branched molecular structure. In some embodiments, the PFPE fluid has a generally linear molecular structure. In some embodiments, the PFPE fluid used in the disclosed TIM is a combination of two or more species or types of PFPE fluid. The type of PFPE used in the TIM will impact the physical properties of the resulting TIM. In some embodiments, the PFPE has a molecular weight of between about 1,500 g/mol and about 30,000 g/mol. In some embodiments, the PFPE oil has a viscosity of at least 50 cSt at a temperature of about 20° C. It will be appreciated that the PFPE fluid used in the TIM may comprise one or more different types of PFPE variants.

In some embodiments, the thermal interface material comprises at least 5% PFPE fluid by weight. In some embodiments, the thermal interface material comprises at least 10%, at least 15%, at least 20%, at least 25%, or at least 30% PFPE fluid by weight. In some embodiments, the thermal interface material comprises between 10% and 45% PFPE fluid by weight.

The heat conductive particles used in the disclosed heat conductive materials are generally metals and metal oxides due to their relatively high heat conductivity. In some embodiments, the heat conductive particles comprise one or a combination of SiC, BeO, Cu₂O, AlN, BN, Si₃N₄, MgO, ZnO, Al₂O₃, SiO₂, and/or Al₂TiO₅. Potential alternative thermal fillers include fluorinated heat conductive materials such as CF, MgF₂, AlF₃, CuF₂, and/or ZnF₂.

As thermal interface materials may be used with electronics that may be sensitive to magnetic fields, in some embodiments, the use of non-ferrous and/or generally non-magnetic heat conductive particles may be beneficial.

The size of the heat conductive particles used may impact the physical properties of the thermal interface material. In some embodiments, the heat conductive particles are less than about 50 μm in size. In some embodiments, the heat conductive materials are between about 0.1 μm and 100 μm in size. In some embodiments, the heat conductive particles are generally spherical.

In some embodiments, the TIM contains a specified range of heat conductive particle surface area per unit of weight. In such embodiments, the size and shape of the heat conductive particles are generally known as well as the weight percent of the heat conductive particles relative to the total weight of the TIM material or relative to the weight percent of the fluorine containing fluid.

In some embodiments, the heat conductive particles have a thermal conductivity of at least 30 W/mK. In some embodiments, the heat conductive particles have a thermal conductivity of between about 60 and about 70 W/mK. In some embodiments, the heat conductive particles have a thermal conductivity of between about 125 and about 135 W/mK.

Creating a stable dispersion of heat conductive particles in PFPE presents a variety of challenges. The surface of the heat conductive particles typically has a low affinity for PFPE fluid and the heat conductive particles tend to agglomerate. To facilitate the dispersion of heat conductive particles, a dispersant may be added to the TIM or the surface of the particles may be modified using a surface treatment agent.

In some embodiments, the surface treatment agent comprises a fluorine containing moiety, such as, for example, a PFPE moiety, that is presented on the surface of a plurality of heat conductive particles. In some embodiments, the presented fluorine containing moiety is bound to a metal binding group. The metal binding group is a group capable of covalently binding to a metal or a metal oxide, such as a phosphate, carboxylate, thiol, amine, and silane. In some embodiments, the fluorine containing moiety is bound to the metal binding group using one or more linking groups. Some embodiments of a linking group arrangement include a triisocyanurate group covalently bound to a perfluoropolyether and an acrylate ester covalently bound to the triisocyanurate group. In some embodiments, the surface treatment agent comprises alcohol, carboxylic acid, ester, and/or phosphonic acid groups.

In some embodiments, the surface treatment agent comprises PFPE and silane. In some embodiments, the perfluoro(poly)ether group containing silane can be a compound of the Formula (2) and/or Formula (3) where, Formula (2) is represented by [A]_{b1}Q² [B]_{b2} and Formula (3) is represented by [B]_{b2}Q² [A]Q²[B]_{b2},

where, Q² is a linking group having a valency of (b1+b2), A is a group represented by R^{f3}—O—R^{f2}— or —R^{f3}—O—R^{f2}—, where R^{f2} is a poly(oxyfluoroalkylene) chain, and R^{f3} is a perfluoroalkyl group or perfluoroalkylene group,

B is a monovalent group having one —R¹²—(SiR²ᵣ—X²₂₋ᵣ), where R¹² is an organic group preferably hydrocarbon group having 2 to 10 carbon atoms that optionally has an ether oxygen atom between the carbon-carbon atoms or at an end opposite to a side bonded with Si or optionally has —NH— between the carbon-carbon atoms, R² are each independently a hydrogen atom or a monovalent hydrocarbon group having 1 to 6 carbon atoms, the hydrocarbon group optionally containing a substituent, X² are each independently a hydroxyl group or a hydrolyzable group, and r is an integer of 0 to 2, and including no fluorine atom,

Q² and B include no cyclic siloxane structure,

b1 is an integer of 1 to 3,

b2 is an integer of 1 to 9, and

in a case where b1 is 2 or more, b1 pieces of A may be identical or different, and

b2 pieces of B may be identical or different.

In some embodiments, R^{f2} in Formula (2) and/or Formula (3) is a group represented by —(CₐᵢF₂ₐᵢO)ₙ—, where ai is an integer of 1 to 6, n is an integer of 2 or more, and the —CₐF₂ₐO— units may be identical or different. In embodiments, R^{f2} in Formula (2) and/or Formula (3) is a group represented by a group —(CF₂CF₂CF₂CF₂CF₂CF₂O) ₙ₁—(CF₂CF₂CF₂CF₂CF₂O)ₙ₂—(CF₂CF₂CF₂CF₂O)ₙ₃—(CF₂CF₂CF₂O)ₙ₄—(CF(CF₃)CF₂O)ₙ₅—(CF₂CF₂O)ₙ₆—(CF₂O)ₙ₇—, where n1, n2, n3, n4, n5, n6, and n7 are each independently an integer of 0 or more, the sum of n1, n2, n3, n4, n5, n6, and n7 is 2 or more, and the repeating units may exist in block, alternately, or randomly.

In some embodiments, the pefluoro(poly)ether group containing silane compound can be a compound of any of the formulae (A1), (A2), (B1), (B2), (C1), (C2), (D1) and (D2) as shown and described in U.S. Publication 2019/0031828, which is incorporated herein by reference in its entirety. The compound of formula (2) can be selected from compound selected from the group consisting of (A1), (A2), (B1), (B2), (C1), (C2), (D1) and (D2):

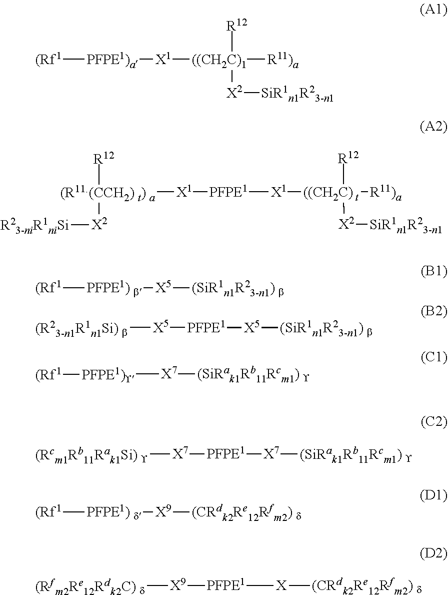

In the formula described above, PFPE is each independently —(OC₄F₈)ₐ—(OC₃F₆)_{b}—(OC₂F₄)_{c}—(OCF₂)_{d}—, and corresponds to a perfluoro(poly)ether group. Herein, a, b, c and d are each independently 0 or an integer of 1 or more. The sum of a, b, c, and d is 1 or more. Preferably, a, b, c, and d are each independently an integer of 0 or more and 200 or less, for example an integer of 1 or more and 200 or less, more preferably each independently an integer of 0 or more and 100 or less. The sum of a, b, c and d is preferably 5 or more, more preferably 10 or more, for example 10 or more and 100 or less. The occurrence order of the respective repeating units in parentheses with the subscript a, b, c or d is not limited in the formula. Among these repeating units, the —(OC₄F₈)— group may be any of —(OCF₂CF₂CF₂CF₂)—, —(OCF (CF₃) CF₂CF₂)—, —(OCF₂CF (CF₃) CF₂)—, —(OCF₂CF₂CF(CF₃))—, —(OC(CF₃)₂CF₂)—, —(OCF₂C (CF₃)₂)—, —(OCF (CF₃) CF (CF₃))—, —(OCF (C₂F₅) CF₂)— and —(OCF₂CF(C₂F))—, preferably —(OCF₂CF₂CF₂CF₂) —. The —(OC₃F₆)— group may be any of —(OCF₂CF₂CF₂)—, —(OCF (CF₃) CF₂)— and —(OCF₂CF (CF₃))—, preferably —(OCF₂CF₂CF₂)—. The —(OC₂F₄)-group may be any of —(OCF₂CF₂)— and —(OCF(CF₃))—, preferably —(OCF₂CF₂)—.

In some embodiments, PFPE is —(OC₃F₆)_{b}— wherein b is an integer of 1 or more and 200 or less, preferably 5 or more and 200 or less, more preferably 10 or more and 200 or less, preferably —(OCF₂CF₂CF₂)_{b}— wherein b is an integer of 1 or more and 200 or less, preferably 5 or more and 200 or less, more preferably 10 or more and 200 or less, or (OCF(CF₃)CF₂)_{b}— wherein b is an integer of 1 or more and 200 or less, preferably 5 or more and 200 or less, more preferably 10 or more and 200 or less, more preferably —(OCF₂CF₂CF₂)_{b}— wherein b is an integer of 1 or more and 200 or less, preferably 5 or more and 200 or less, more preferably 10 or more and 200 or less.

In some embodiments, PFPE is —(OC₄F₈)ₐ₁—(OC₃F₆)_{b1}—(OC₂F₄)_{c1}—(OCF₂)_{d1}— wherein a1 and b1 are each independently an integer of 0 or more and 30 or less, c1 and d1 are each independently an integer of 1 or more and 200 or less, preferably 5 or more and 200 or less, more preferably 10 or more and 200 or less, and the occurrence order of the respective repeating units in parentheses with the subscript a, b, c or d is not limited in the formula; preferably —(OCF₂CF₂CF₂CF₂)ₐ₁—(OCF₂CF₂CF₂)_{b1}—(OCF₂CF₂)_{c1}—(OCF₂)_{d1}—. In one embodiment, PFPE may be —(OC₂F₄)_{c1}—(OCF₂)_{d1}— wherein c and d are each independently an integer of 1 or more and 200 or less, preferably 5 or more and 200 or less, more preferably 10 or more and 200 or less, and the occurrence order of the respective repeating units in parentheses with the subscript c or d is not limited in the formula.

In some embodiments, PFPE is a group of —(R⁷—R⁸)_{f}—. In the formula, R¹ is OCF₂ or OC₂F₄, preferably OC₂F₄. That is, preferably PFPE is a group of —(OC₂F₄—R⁸)_{f}—. In the formula, R⁸ is a group selected from OC_{Z}F₄, OC₃F₆ and OC₄F₈, or a combination of 2 or 3 groups independently selected from these groups. Examples of the combination of 2 or 3 groups independently selected from OC₂F₄, OC₃F₆ and OC₄F₈ include, but not limited to, for example, —OC₂F₄OC₃F₆—, —OC₂F₄OC₄F₈—, —OC₃F₆OC₂F₄—, —OC₃F_{b}OC₃F₆—, —OC₃F₆OC₄F₈—, —OC₄F₈OC₄F₈—, —OC₄F₈OC₃F₆—, —OC₄F₈OC_F₄—, —OC₂F₄OC₂F₄OC₃F₆—, —OC₂F₄OC₄F₄OC₄F₈—, —OC₂F₄OC₃F₆OC₂F₄—, —OC₂F₄OC₃F₆OC₃F₆—, —OC₃F₆OC₃F₆OCF₄—, —OC₄F₆OC₂F₄OC₂F₄—, and the like. f is an integer of 2-100, preferably an integer of 2-50. In the above-mentioned formula, OC₂F₄, OC₃F₆ and OC₄F₈ may be straight or branched, preferably straight. In this embodiment, PFPE is preferably —(OC₂F₄—OC₃F₆)_{f}— or —(OC₂F₄—OC₄F₈)_{f}—.

In the formula, Rf is an alkyl group having 1-16 carbon atoms which may be substituted by one or more fluorine atoms.

The “alkyl group having 1-16 carbon atoms” in the alkyl having 1-16 carbon atoms which may be substituted by one or more fluorine atoms may be straight or branched, and preferably is a straight or branched alkyl group having 1-6 carbon atoms, in particular 1-3 carbon atoms, more preferably a straight alkyl group having 1-3 carbon atoms.

Rf is preferably an alkyl having 1-16 carbon atoms substituted by one or more fluorine atoms, more preferably a CF₂H—C₁₋₁₅ fluoroalkylene group, more preferably a perfluoroalkyl group having 1-16 carbon atoms.

The perfluoroalkyl group having 1-16 carbon atoms may be straight or branched, and preferably is a straight or branched perfluoroalkyl group having 1-6 carbon atoms, in particular 1-3 carbon atoms, more preferably a straight perfluoroalkyl group having 1-3 carbon atoms, specifically —CF₃, —CF₂CF₃ or —CF₂CF₂CF₃.

In the formula, R¹ is each independently at each occurrence a hydroxyl group or a hydrolyzable group.

In the formula, R² is each independently at each occurrence a hydrogen atom or an alkyl group having 1-22 carbon atoms preferably an alkyl group having 1-4 carbon atoms.

The “hydrolyzable group” as used herein represents a group which is able to be removed from a backbone of a compound by a hydrolysis reaction. Examples of the hydrolyzable group include —OR, —OCOR, —O—N═CR₂, —NR₂, —NHR, halogen (wherein R is a substituted or non-substituted alkyl group having 1-4 carbon atoms), preferably —OR (i.e. an alkoxy group). Examples of R include a non-substituted alkyl group such as a methyl group, an ethyl group, a propyl group, an isopropyl group, an n-butyl group, an isobutyl group; and a substituted alkyl group such as a chloromethyl group. Among them, an alkyl group, in particular a non-substituted alkyl group is preferable, a methyl group or an ethyl group is more preferable. The hydroxyl group may be, but is not particularly limited to, a group generated by hydrolysis of a hydrolyzable group.

In the formula, R¹¹ is each independently at each occurrence a hydrogen atom or a halogen atom. The halogen atom is preferably an iodine atom, a chlorine atom, a fluorine atom, more preferably a fluorine atom.

In the formula, R¹² is each independently at each occurrence a hydrogen atom or a lower alkyl group. The lower alkyl group is preferably an alkyl group having 1-20 carbon atoms, more preferably an alkyl group having 1-6 carbon atoms, for example a methyl group, an ethyl group, an propyl group, or the like.

In the formula, n1 is, independently per a unit (—SiR¹ₙ₁R²₃₋ₙ₁), an integer of 0-3, preferably 0-2, more preferably 0. All of n1 are not simultaneously 0 in the formula. In other words, at least one R¹ is present in the formula.

In the formula, X¹ is each independently a single bond or a 2-10 valent organic group. X¹ is recognized to be a linker which connects between a perfluoropolyether moiety (i.e., an Rf-PFPE moiety or —PFPE— moiety) providing mainly water-repellency, surface slip property and the like and a silane moiety (i.e., a group in parentheses with the subscript a) providing an ability to bind to a base material in the compound of the formula (A1) and (A2) Therefore, X¹ may be any organic group as long as the compound of the formula (A1) and (A2) can stably exist.

In the formula, α is an integer of 1-9, and α′ is an integer of 1-9. α and α′ may be varied depending on the valence number of the X¹ group. In the formula (A1), the sum of α and α′ is the valence number of X¹. For example, when X¹ is a 10 valent organic group, the sum of α and α′ is 10, for example, a is 9 and α′ is 1, α is 5 and α′ is 5, or α is 1 and α′ is 9. When X¹ is a divalent organic group, α and α′ are 1. In the formula (A2), a is a value obtained by subtracting 1 from the valence number of X¹.

X¹ is preferably a 2-7 valent, more preferably 2-4 valent, more preferably a divalent organic group.

In some embodiments, X¹ is a 2-4 valent organic group, a is 1-3, and α′ is 1.

In embodiments of (A1), (A2), (B1), (C1), (C2), (D1), and (D2), PFPE is each independently at each occurrence a group of the formula:

—(OC₄F₈)ₐ₁—(OC₃F₆)_{b1}—(OC₂F₄)_{c1}—(OCF₂)_{d1}—

wherein a1, b1, c1 and d1 are each independently an integer of 0-200 with (a1+b1+c1+d1)≥1, and the order of the repeating units in parentheses with the subscripts a1-d1 is not limited;

Rf is each independently at each occurrence C1-16-alkyl optionally substituted by F;

R¹ is each independently at each occurrence OH or a hydrolyzable group;

R² is each independently at each occurrence H or C1-22-alkyl;

R¹¹ is each independently at each occurrence H or halogen;

R12 is each independently at each occurrence H or lower alkyl;

n1 is, independently per a unit (—SiR¹ₙ₁R²₃₋ₙ₁), an integer of 0-3;

at least one n1 is an integer of 1-3 in the formulae (A1), (A2) , (B1) and (B2);

X¹ is each independently a single bond or a 2-10 valent organic group;

X² is each independently at each occurrence a single bond or a divalent organic group;

t is each independently at each occurrence an integer of 1-10;

α is each independently an integer of 1-9;

α′ is each independently an integer of 1-9;

X⁵ is each independently a single bond or a 2-10 valent organic group;

β is each independently an integer of 1-9;

β′ is each independently an integer of 1-9;

X⁷ is each independently a single bond or a 2-10 valent organic group;

γ is each independently an integer of 1-9;

γ′ is each independently an integer of 1-9;

R^{a} is each independently at each occurrence —Z¹—SiR⁷¹ₚ₁R⁷²_{q}1R⁷³ᵣ₁;

Z¹ is each independently at each occurrence O or a divalent organic group;

R⁷¹ is each independently at each occurrence R^{a′} having the same definition as R^{a};

R⁷² is each independently at each occurrence OH or a hydrolyzable group;

R⁷³ is each independently at each occurrence H or lower alkyl;

p1 is each independently at each occurrence an integer of 0-3;

q1 is each independently at each occurrence an integer of 0-3;

r1 is each independently at each occurrence an integer of 0-3;
at least one q1 is an integer of 1-3 in the formula (C1) and (C2);

and in R^{a} the number of Si atoms which are straightly linked via the Z1 group is ≤5;

R^{b} is each independently at each occurrence OH or a hydrolyzable group;

R^{c} is each independently at each occurrence H or lower alkyl;

k1 is each independently at each occurrence an integer of 1-3;

11 is each independently at each occurrence an integer of 0-2;

m1 is each independently at each occurrence an integer of 0-2;
and (k1+11+m1)=3 in each unit in parentheses with the subscript γ;

X⁹ is each independently a single bond or a 2-10 valent organic group;

δ is each independently an integer of 1-9;

δ′ is each independently an integer of 1-9;

R^{d} is each independently at each occurrence —Z²—CR⁸¹ₚ₂R⁸²_{q2}R⁸³ᵣ₂;

Z2 is each independently at each occurrence O or a divalent organic group;

R81 is each independently at each occurrence R^{d′};

R^{d′} has the same definition as that of R^{d} ;
in R^{d}, the number of C atoms which are straightly linked via the Z² group is ≤5;

R82 is each independently at each occurrence —Y—SiR⁸⁵ₙ₂R⁸⁶₃₋ₙ₂;

Y each independently at each occurrence a divalent organic group;

R⁸⁵ is each independently at each occurrence OH or a hydrolyzable group;

R⁸⁶ is each independently at each occurrence H or lower alkyl;

n2 is an integer of 1-3 independently per unit (—Y—SiR⁸⁵ₙ₂R⁸⁶₃₋ₙ₂);
in formulae (D1) and (D2), at least one n2 is an integer of 1-3;

R⁸³ is each independently at each occurrence H or a lower alkyl group;

p2 is each independently at each occurrence an integer of 0-3;

q2 is each independently at each occurrence an integer of 0-3;

r2 is each independently at each occurrence an integer of 0-3;

R^{e} is each independently at each occurrence —Y—SiR⁸⁵ₙ₂R⁸⁶ₙ₂;

R^{f} is each independently at each occurrence H or lower alkyl;

k2 is each independently at each occurrence an integer of 0-3;

12 is each independently at each occurrence an integer of 0-3; and

m2 is each independently at each occurrence an integer of 0-3;

in formulae (D1) and (D2), at least one q2 is 2 or 3, or at least one 12 is 2 or 3

In some embodiments, PFPE is a group of any of the following formulas (i) to (iv):

—(OCF₂CF₂CF₂)_{b} (i)

wherein b is an integer of 1-200;

—(OCF (CF₃) CF₂)_{b}— (ii)

wherein b is an integer of 1-200;

—(OCF₂CF₂CF₂CF₂)ₐ—(OCF₂CF₂CF₂)_{b}—(OCF₂CF₂)_{c}—(OCF₂)_{d}— (iii)

wherein a and b are each independently 0 or an integer of 1-30, c and d are each independently an integer of 1-200, and the occurrence order of the respective repeating units in parentheses with the subscript a, b, c or d is not limited in the formula;

or

—(R⁷—R⁸)_{f} (iv)

wherein R⁷ is OCF₂ or OC₂F₄.

R⁸ is a group selected from OC₂F₄, OC₃F₆ and OC₄F₈; and

f is an integer of 2-100.

In some embodiments, X⁵, X⁷ and X⁹ are each independently a 2 valent organic group γ, γ and δ are 1, and β′, γ′ and δ′ are 1.

In some embodiments, X⁵, X⁷ and X⁹ are each independently —(R³¹)_{p′}—(X^{a})_{q′}—

wherein:

R³¹ is each independently a single bond, —(CH₂)_{s′}— (wherein

s′ is an integer of 1-20) or a o-, m- or p-phenylene group;

X^{a} is —(X^{b})_{1′}— wherein

1′ is an integer of 1-10;

X^{b} is each independently at each occurrence selected from —O—, —S—, o-, m- or p-phenylene, —C(O)O—, —Si(R³³)₂—, —(Si (R³³)₂O)_{m′}—Si (R³³)₂— (wherein m′ is an integer of 1-100), —CONR³⁴—, —O—CONR³⁴—, —NR³⁴— and —(CH₂)_{n′}— (wherein n′ is an integer of 1-20);

R33 is each independently at each occurrence phenyl, C₁₋₆-alkyl or C₁₋₆-alkoxy;

R³⁴ is each independently at each occurrence H, phenyl or C₁₋₆-alkyl;
R³¹ and X^{a} is may be substituted with one or more substituents selected from F, C₁₋₃-alkyl and C₁₋₃-fluoroalkyl.

p′ is 0, 1 or 2;

q′ is 0 or 1;
and at least one of p′ and q′ is 1,
and the order of the repeating units in parentheses with the subscript p′ or q′ is not limited.

In some embodiments, X⁵, X⁷ and X⁹ are each independently selected from:

—CH₂O(CH₂)₂—,

—CH₂O(CH₂)₃—,

—CH₂O(CH₂)₆—,

—CH₂O(CH₂)₃Si(CH₃)₂OSi (CH₃)₂ (CH₂)₂—,

—CH₂O(CH₂)₃Si(CH₃)₂OSi (CH₃)₂OSi (CH₃)₂(CH₂)₂—,

—CH₂O(CH₂)₃Si(CH₃)₂O(Si (CH₃)₂O(Si (CH₃)₂O)₂Si(CH₃)₂(CH₂)₂—,

—CH₂O(CH₂)₃Si(CH₃)₂O(Si (CH₃)₂O(Si (CH₃)₂O)₃Si(CH₃)₂(CH₂)₂—,

—CH₂O(CH₂)₃Si(CH₃)₂O(Si (CH₃)₂O(Si (CH₃)₂O)₁₀Si(CH₃)₂(CH₂)₂—,

—CH₂O(CH₂)₃Si(CH₃)₂O(Si (CH₃)₂O(Si (CH₃)₂O)₂₀Si(CH₃)₂(CH₂)₂—,

—CH₂OCF₂CHFOCF₂—,

—CH₂OCF₂CHFOCF₂CF₂—,

—CH₂OCF₂CHFOCF₂CF₂CF₂—,

—CH₂OCH₂CF₂CF₂OCF₂—,

—CH₂OCH₂CF₂CF₂OCF₂CF₂—,

—CH₂OCH₂CF₂CF₂OCF₂CF₂CF₂—,

—CH₂OCH₂CF₂CF₂OCF (CF₃) CF₂OCF₂—,

—CH₂OCH₂CF₂CF₂OCF (CF₃) CF₂OCF₂CF₂—,

—CH₂OCH₂CF₂CF₂OCF (CF₃) CF₂OCF₂CF₂CF₂—,

—CH₂OCH₂CHFCF₂OCF₂—,

—CH₂OCH₂CHFCF₂OCF₂CF₂—,

—CH₂OCH₂CHFCF₂OCF₂CF₂CF₂—,

—CH₂OCH₂CHFCF₂OCF (CF₃) CF₂OCF₂—,

—CH₂OCH₂CHFCF₂OCF (CF₃) CF₂OCF₂CF₂—,

—CH₂OCH₂CHFCF₂OCF (CF₃) CF₂OCF₂CF₂CF₂—, —CH₂OCH₂(CH₂)₇CH₂Si (OCH₃)₂OSi (OCH₃)₂(CH₂)₂Si (OCH₃)₂OSi (OCH₃)₂ (CH₂)₂—,

—CH₂OCH₂CH₂CH₂Si(OCH₃)₂OSi(OCH₃)₂(CH₂)₃—,

—CH₂OCH₂CH₂CH₂Si(OCH₂CH₃)₂OSi(OCH₂CH₃)₂(CH₂)₃—,

—CH₂OCH₂CH₂CH₂Si(OCH₃)₂OSi(OCH₃)₂(CH₂)₂—,

—CH₂OCH₂CH₂CH₂Si(OCH₂CH₃)₂OSi(OCH₂CH₃)₂(CH₂)₂—,

—(CH₂)₂—,

—(CH₂)₃—,

—(CH₂)₄—,

—(CH₂)₅—,

—(CH₂)₆—,

—(CH₂)₂—Si (CH₃)₂—(CH₂)₂—

—CONH—(CH₂)—,

—CONH—(CH₂)₂—,

—CONH—(CH₂)₃—,

—CON(CH₃)—(CH₂)₃—,

—CON(Ph)-(CH₂)₃— wherein Ph is a phenyl group,

—CONH—(CH₂)₆—,

—CON(CH₃)—(CH₂)₆—,

—CON(Ph)-(CH₂)₆— wherein Ph is a phenyl group,

—CONH—(CH₂)₂NH (CH₂)₃—,

—CONH—(CH₂)₆NH (CH₂)₃—,

—CH₂O—CONH—(CH₂)₃—,

—CH₂O—CONH—(CH₂)₆—,

—S—(CH₂)₃—,

—(CH₂)₂S (CH₂)₃—,

—CONH—(CH₂)₃Si(CH₃)₂OSi(CH₃)₂(CH₂)₂—,

—CONH—(CH₂)₃Si(CH₃)₂OSi(CH₃)₂O)₂Si(CH₃)₂(CH₂)₂—,

—CONH—(CH₂)₃Si(CH₃)₂O(Si(CH₃)₂O)₂Si(CH₃)₂(CH₂)₂—,

—CONH—(CH₂)₃Si(CH₃)₂O(Si(CH₃)₂O)₃Si(CH₃)₂(CH₂)₂—,

—CONH—(CH₂)₃Si(CH₃)₂O(Si(CH₃)₂O)₁₀Si(CH₃)₂(CH₂)₂—,

—CONH—(CH₂)₃Si(CH₃)₂O(Si(CH₃)₂O)₂₀Si(CH₃)₂(CH₂)₂—,

—C(O)O—(CH₂)₃—,

—C(O)O—(CH₂)₆—,

—CH₂—O—(CH₂)₃—Si(CH₃)₂—(CH₂)₂—Si(CH₃)₂—(CH₂)₂—,

—CH₂—O—(CH₂)₃—Si(CH₃)₂—(CH₂)₂—Si(CH₃)₂—CH(CH₃)—,

—CH₂—O—(CH₂)₃—Si(CH₃)₂—(CH₂)₂—Si(CH₃)₂—(CH₂)₃—,

—CH₂—O—(CH₂)₃—Si(CH₃)₂—(CH₂)₂—Si(CH₃)₂—CH(CH₃)—CH₂—,

—OCH₂—,

—O(CH₂)₃—,

—OCFHCF₂—,

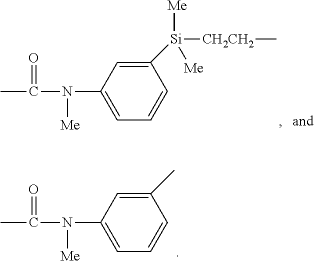

In some embodiments, X⁵, X⁷ and X⁹ are each independently selected from:

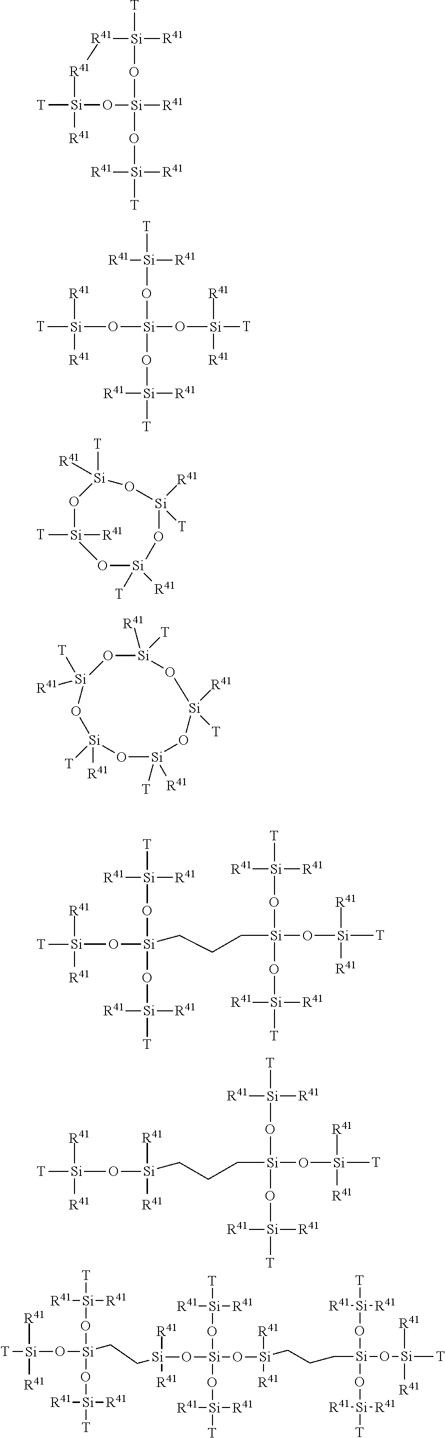

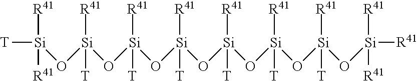

wherein in each group, at least one of T is the following group attached to PFPE in the formulae (A1), (A2), (B1), (B2) , (C1) , (C2) , (D1) and (D2):

—CH₂O(CH₂)₂—,

—CH₂O(CH₂)₃—,

—CF₂O(CH₂)₃—,

—(CH₂)₂—,

—(CH₂)₃—,

—(CH₂)₄—,

—CONH—(CH₂)—,

—CONH—(CH₂)₂—,

—CONH—(CH₂)₃—,

—CON(CH₃)—(CH₂)₃—,

—CON(Ph)-(CH₂)₃— wherein Ph is phenyl, and

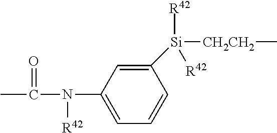

at least one of the other T is —(CH₂)ₙ₊— (wherein n′ is an integer of 2-6) attached to the carbon atom or the Si atom in the formulae (A1), (A2), (B1), (B2), (C1), (C2), (D1) and (D2), and if present, the others T are each independently methyl, phenyl, C1-6-alkoxy, or a radical scavenger group or an ultraviolet ray absorbing group,

R⁴¹ is each independently H, phenyl, C₁₋₆-alkoxy or C₁₋₆-alkyl, and

R⁴² is each independently H, C₁₋₆-alkyl or C₁₋₆-alkoxy.

The number average molecular weight of the perfluoropolyether group containing silane compound of the formulae (A1), (A2), (B1), (B2), (C1), (C2), (D1) and (D2) may be, but not particularly limited to, 5×10²-1×10⁵. The number average molecular weight may be preferably 2,000-30,000, more preferably 3,000-10,000, further preferably

It is noted that, in the present invention, the “number average molecular weight” is measured by GPC (Gel Permeation Chromatography) analysis.

The number average molecular weight of the PFPE portion of the perfluoro(poly)ether group containing silane compound contained in the surface-treating agent of the present invention may be, not particularly limited to, preferably 1,500-30,000, more preferably 2,500-10,000, further preferably 3,000-8,000.

In some embodiments, the surface treatment agent is described by the formula:

R^{F}—Q—SiR¹ₚX₃₋ₚ (I)

where R^{F} is CₙF₍₂ₙ₊₁₎ where n is 1-16;

Q is a divalent C1-C6 hydrocarbon group;

R¹ is independently a monovalent C1-C6 hydrocarbon group;

X is independently a hydroxy group or a hydrolyzable group; and

p is 0-2.

The surface of the heat conductive particles may be modified prior to dispersing the heat conductive particles in PFPE fluid by reacting the particles with the surface treatment agent such that the heat conductive particles present a PFPE group on their surface. The modified heat conductive particles may then be dispersed within the PFPE fluid or other fluorine containing fluid.

In some embodiments, before the surface treatment agent is bound to the heat conductive particle, the surface treatment agent contains both a PFPE moiety and a hydrolysable silane moiety. The surface treatment agent may be applied by a method involving covalently bonding the metal or metal oxide surface of the heat conductive particles to the silane moiety or other metal binding group and covalently bonding the metal binding group to the PFPE or other fluorine containing group. These basic steps can be performed in any order. Reacting the metal binding group to the metal or metal oxide surface first has the advantage of reducing or eliminating the number of reactions than can be formed between the metal binding groups, potentially blocking reactive sites. A specific embodiment of the method comprises covalently bonding the metal or metal oxide surface to the metal binding group to form a monolayer on the metal or metal oxide surface, and subsequently exposing the monolayer to the molecule comprising in the PFPE group in the presence of an initiator.

In some embodiments, the surface treatment described above may be performed after the heat conductive particles have been added to a fluorine containing fluid such as PFPE fluid. In some embodiments, a solvent or other additive may be used to lower the viscosity of the PFPE fluid while the heat conductive particles are being modified.

In some embodiments the surface treatment reaction described above may be performed by blending the surface treatment agent and the PFPE fluid prior to adding the heat conductive particles. In such embodiments, the surface treatment reaction occurs within the fluorine containing fluid. In some embodiments, a solvent or other additive may be added to decrease the viscosity of the fluorine containing fluid to facilitate the modification of the heat conductive particles.

In this context “covalently bonding” a first group to a second group encompasses reactions that covalently bond a molecule that includes the first group to a molecule that includes the second group, even if no bond is directly formed between an atom in the first group to an atom in the second group. The metal/metal oxide binding group can be reacted with the metal or metal oxide surface by various methods, including blending. In some embodiments of the method the metal binding group is part of a first acrylate ester molecule, and the PFPE group is part of a second acrylate ester molecule. The two acrylate esters can then be reacted to form a pentanone ester in the presence of an initiator. In this arrangement, the initiator must function to break the terminal carbon-carbon double bond in one or both molecules, converting the molecule to a radical. Some embodiments of the method employ a photoinitiator, such as an organic peroxide or benzoyl peroxide. Further embodiments of the method employ a photoinitiator of the α-hydroxyketone class, as well as α-aminoketones, phenylglyoxylates—largely determined by solubility and initiation/excitation wavelength. The mixture of photoinitiator and acrylate esters can then be exposed to electromagnetic radiation of an appropriate wavelength to produce radical species (such as ultraviolet).

In some embodiments, the surface treatment agent is heat conducting. The use of a heat conducting surface treatment agent facilitates the thermal conductivity of the heat conducting particles and the TIM as a whole.

The disclosed high temperature, low outgas thermal interface material is designed to provide the necessary thermal conductivity between a heat source and a heat sink even at higher temperatures.

In some embodiments, the TIM may be exposed to temperatures as high as 200° C., 250° C., 300° C., or 350° C. without significantly decomposing or degrading.

The physical form of the thermal interface material depends in part on the ratio of heat conductive particles to PFPE fluid. In some embodiments, the TIM is a viscous liquid or liquid dispersion. Inn some embodiments, the TIM is a high viscosity material. In some embodiments, the TIM is a paste. In some embodiments, the TIM is a deformable solid.

In some embodiments, the thermal interface material comprises at least 55% heat conductive particles by weight. In some embodiments, the thermal interface material comprises at least 70%, at least 80%, at least 85%, at least 90%, or at least 95% heat conductive particles by weight. In some embodiments, the thermal interface material comprises between 80% and 95% heat conductive particles by weight.

The disclosed thermal interface material is a low outgas, high temperature thermal interface material. In some embodiments, the TIM loses less than 1% of its total mass during ASTM-D972-16 protocol testing, known as Standard Test Method for Evaporation Loss of Lubricating Greases and Oils, ASTM D2595 protocol testing, known as Standard Test Method for Evaporation Loss of Lubricating Greases Over Wide-Temperature Range or during ASTM-E595 protocol testing, known as Standard Test Method for Total Mass Loss and Collected Volatile Condensable Materials from Outgassing in a Vacuum Environment. In some embodiments, the TIM outgasses less than 0.6% of its total mass after 72 hours of exposure to a temperature of at least 200° C. at atmospheric pressure.

In some embodiments, the physical properties of the TIM depend on the ratio of PFPE fluid to heat conductive particles in the TIM. The heat conductive particles generally comprise material that will not lose mass when exposed to temperatures in the range of 200 to 500 C or to less than atmospheric pressures. In some embodiments, the amount of mass lost from the TIM as the TIM is exposed to high temperatures and/or reduced pressure increases as the weight ratio of PFPE fluid to heat conductive particles increases.

In some embodiments, the disclosed TIM is applied to a solid heat conductive film such as, for example, a copper or aluminum film. In such embodiments, the TIM material is coated on to or otherwise applied to at least one side of the solid film to form a heat conductive film. A viscous or deformable TIM may be used to create a high degree of thermal conductivity between a heat producing or heat communicating component and the solid film. It will be appreciated that the viscous or deformable TIM may be used as a gap filler to reduce air pockets that may exist between a component and the solid film.

In some embodiments, the thermally conductive film comprises an electrically conductive material, such as, for example, aluminum or copper. In some embodiments, the thermally conductive film comprises materials that are electric insulators.

In some embodiments, the heat conductive foil may be arranged as a sheet, roll, or tape. In some embodiments, the heat conductive foil may be cut to a particular size or shape for application to the heat releasing surface of a particular component.

In some embodiments, the disclosed TIM may be applied to electronic components and maintained in position with a release layer. The electronic components may be supplied with the TIM material pre-applied such that the end user removes the release layer, thereby exposing the TIM material. In such embodiments, the electronic component may be installed without the end user applying the TIM as the electronic component has the TIM pre-applied.

Those skilled in the art will recognize improvements and modification to the preferred embodiments of the present disclosure. All such improvements and modifications are considered within the scope of the concepts disclosed herein and the claims that follow. It is to be understood that any given elements of the disclosed embodiments of the invention may be embodied in a single structure, a single step, a single substance, or the like. Similarly, a given element of the disclosed embodiment may be embodied in multiple structures, steps, substances, or the like.

The foregoing description illustrates and describes the processes, machines, manufactures, compositions of matter, and other teachings of the present disclosure. Additionally, the disclosure shows and describes only certain embodiments of the processes, machines, manufactures, compositions of matter, and other teachings disclosed, but, as mentioned above, it is to be understood that the teachings of the present disclosure are capable of use in various other combinations, modifications, and environments and are capable of changes or modifications within the scope of the teachings as expressed herein, commensurate with the skill and/or knowledge of a person having ordinary skill in the relevant art. The embodiments described herein above are further intended to explain certain best modes known of practicing the processes, machines, manufactures, compositions of matter, and other teachings of the present disclosure and to enable others skilled in the art to utilize the teachings of the present disclosure in such, or other, embodiments and with the various modifications required by the particular applications or uses. Accordingly, the processes, machines, manufactures, compositions of matter, and other teachings of the present disclosure are not intended to limit the exact embodiments and examples disclosed herein.

### INDUSTRIAL APPLICABILITY

The fluorinated thermal interface material is used in the electronics, energy storage, and communications industries.

1. A low outgas high temperature thermal interface material comprising:
a heat conductive material dispersed within a perfluoropolyether (PFPE) fluid, wherein the heat conductive material comprises a plurality of heat conductive particles, wherein the surface of the plurality of heat conductive particles is modified with a fluorine containing surface treatment agent, and wherein the thermal interface material comprises between 55% and 90% heat conductive material by weight.

2. (canceled)

3. The thermal interface material of claim 1, wherein the thermal interface material comprises at least 85% heat conductive particles by weight.

4. The thermal interface material of claim 1, wherein the thermal interface material comprises between 10% and 45% PFPE fluid by weight

5. The thermal interface material of claim 1, wherein the thermal interface material loses less than about 1% of total mass during ASTM D972 or ASTM D2595 protocol testing.

6. The thermal interface material of claim 1, wherein the thermal interface material outgasses less than 0.6% of total mass after 72 hours of exposure to a temperature of at least 200° C.

7. The thermal interface material of claim 1, wherein the thermal interface material is a liquid.

8. The thermal interface material of claim 1, wherein the surface treatment agent comprises a fluorine containing moiety.

9. The thermal interface material of claim 1, wherein the surface treatment agent is covalently bound to the surface of the heat conductive particles and wherein the surface treatment agent comprises a PFPE moiety.

10. The thermal interface material of claim 1, wherein the surface treatment agent is covalently bound to the heat conductive particle and wherein the surface treatment agent comprises a PFPE moiety and a silane moiety.

11. The thermal interface material of claim 1, wherein the PFPE fluid has a molecular weight between 1,500 and 30,000 g/mol.

12. The thermal interface material of claim 1, wherein the PFPE fluid has a viscosity of at least 50 cSt and the thermal interface material is a paste.

13. The thermal interface material of claim 1, wherein the heat conductive particles are selected from the group consisting of SiC, BeO, Cu₂O, AlN, BN, Si₃N4, MgO, ZnO, Al₂O₃, SiO₂, Al₂TiO₅, CF, MgF₂, AlF₃, CuF₂, and ZnF₂.

14. The thermal interface material of claim 1, wherein the heat conductive particles are non-magnetic.

15. The thermal interface material of claim 1, wherein the heat conductive particles are less than 100 μm in size.

16. The thermal interface material of claim 1, wherein the heat conductive particles are non-magnetic and have a thermal conductivity of at least 20 W/mK.

17. The thermal interface material of claim 1, wherein the thermal interface material is applied to a solid heat conductive film to form a thermal interface film.

18. A method of making a thermal interface material comprising the steps of:
obtaining a plurality of non-magnetic heat conductive particles, wherein the heat conductive particles are less than 100 μm in size and are selected from the group consisting of Mg, MgO, Zn, and ZnO;
obtaining a perfluoropolyether fluid, wherein the perfluoropolyether fluid has a molecular weight between about 1,500 and about 30,000 g/mol;
modifying the heat conductive particles by covalently bonding a surface treatment agent to the surface of the heat conductive particles wherein the surface treatment agent comprises a perfluoropolyether moiety; and
dispersing the modified heat conductive particles within the perfluoropolyether fluid to form a thermal interface material wherein the thermal interface material comprises at least 80% heat conductive particles by weight.

19. A method of making a thermal interface material comprising the steps of:
obtaining a plurality of non-magnetic heat conductive particles;
obtaining a fluorine containing fluid;
obtaining a surface treatment agent comprising a fluorine containing group and a hydrolizable silane group;
blending the surface treatment agent with the fluorine containing fluid;
adding the heat conductive particles to the blended fluorine containing fluid and surface treatment agent;
modifying the heat conductive particles by covalently bonding the surface treatment agent to the surface of the heat conductive particles; and
dispersing the modified heat conductive particles within the fluorine containing fluid to form a thermal interface material.

20. The method of claim 19, wherein the fluorine containing fluid is a PFPE fluid.
